(19) United States
(12) Patent Application Publication
(10) Pub. No.: US 2012/0216446 A1
(43) Pub. Date: Aug. 30, 2012

(54) Bio-based Wax Compositions and Applications

(75) Inventors: Peter Frenkel, Danbury, CT (US); Eric Wisnefsky, Southbury, CT (US); Andrew J. Clock, Southington, CT (US)

(73) Assignee: Galata Chemicals, LLC, Southbury, CT (US)

(21) Appl. No.: 13/033,975

(22) Filed: Feb. 24, 2011

(51) Int. Cl. C11C 5/00

(52) U.S. Cl. 44/275

(57) ABSTRACT

Bio-based wax compositions contain at least one non-hydrogenated epoxy product and at least one wax component containing insect wax. The wax compositions can be used to produce candle compositions such as free-standing candles and container candles, and/or composite materials.

### FIELD OF THE INVENTION

The invention relates to bio-based wax compositions comprising a non-hydrogenated epoxy product and a wax component containing insect wax, methods for producing the same, and to candle applications containing the bio-based wax compositions.

### BACKGROUND OF THE INVENTION

There is a strong consumer demand for candles from renewable feedstock as an environmentally friendly alternative to petroleum-based paraffin candles. Soy candles that are produced from derivatized soybean oil were reported to burn longer and to produce less soot.

Many candle compositions optionally contain colorants, fragrances, insect repellants, antioxidants, and/or UV-stabilizers/color stabilizers.

Beeswax is known and widely used in the manufacture of candles. It is disclosed as such in several books, e.g., (i) Sandie Lea: The encyclopedia of candlemaking techniques; 1999, p. 11; and (ii) Rebecca Ittner: Candlemaking the natural way; 2010, p. 31 and in several patent publications.

The preparation and the use of blends containing both insect waxes and certain vegetable oil derivatives in the preparation candle formulations are known in the prior art.

U.S. Pat. No. 7,128,766 (U.S. Patent Application 2003/0057599) describes candle wax compositions comprising at least 75% of a triacylglycerol component, such as partially hydrogenated vegetable oil, e.g., soybean oil, and about 15% of an additional wax selected from the group consisting of beeswax, paraffin wax, microcrystalline wax, carnauba wax, Montan wax and combinations thereof.

U.S. Patent Application 2003/0022121 describes the preparation of bio-based compositions suitable for candlemaking and comprising from 80-99 parts of vegetable-derived compounds and from 1-20 parts of insect wax, such as beeswax. The vegetable-derived compounds comprise a mixture of vegetable wax, such as esters of stearic acid, and vegetable wax-based acids, such as stearic acid.

U.S. Publication No. 2006/0272200 discusses candle compositions of partially hydrogenated vegetable oils, trans-esterified partially hydrogenated vegetable oils, polyol fatty acid partial esters, such as mono- and diglycerides, trans-esterified polyol fatty acid partial esters such as mono- and diglycerides. The compositions may also contain mineral wax and insect wax.

U.S. Publication No. 2007/0039237 discloses candle compositions of partially hydrogenated vegetable oils having a blend of soy and palm, polyol fatty acid partial esters, and other waxes, such as beeswax, carnauba wax, petroleum wax, and Montan wax, used as migration inhibitors.

The entire contents and disclosure of these references are incorporated herein by reference.

Notwithstanding the above literature, there is a need for wax compositions that are bio-based, burn longer (i.e., have a lower burn rate) and possess a lower tendency to soot and to self-extinguish. The present invention, i.e., wax compositions that contain a non-hydrogenated epoxy product and a wax component such as insect wax, fulfills this need.

### SUMMARY OF THE INVENTION

In a first aspect, the invention is directed to a wax composition comprising at least one non-hydrogenated epoxy product and at least one wax component comprising an insect wax. In one embodiment, the wax composition comprises at least one non-hydrogenated epoxy product selected from the group consisting of epoxides of vegetable oils, epoxides of fatty acid esters, chemically modified derivatives of non-hydrogenated epoxy products, and mixtures thereof.

In a second aspect, the invention is directed to a candle composition comprising at least one non-hydrogenated epoxy product and at least one wax component comprising insect wax. In one embodiment, the candle composition comprises at least one non-hydrogenated epoxy product selected from the group consisting of epoxides of vegetable oils, epoxides of fatty acid esters, chemically modified derivatives of non-hydrogenated epoxy products, and mixtures thereof.

### DETAILED DESCRIPTION OF THE INVENTION

The present invention generally relates to bio-based wax compositions comprising a non-hydrogenated epoxy product and a wax component comprising insect wax. In some embodiments the invention relates to a bio-based wax composition comprising at least one non-hydrogenated epoxy product selected from the group consisting of epoxides of vegetable oils, epoxides of fatty acid esters, and mixtures thereof.

In other embodiments, the non-hydrogenated epoxy product is chemically modified by transesterification of the epoxide-containing components or by acid-catalyzed ring-opening reactions with C₁-C₂₀ alcohols, fatty acids, or C₁-C₂₀ organic acids. The ring opening reactions may be carried out at temperatures of 80 to 150° C., e.g., at temperatures of 90 to 100° C. Suitable acidic catalysts include mineral acids or lower organic carboxylic acids, such as sulfuric acid, phosphoric acid, formic acid, trifluoromethane sulfonic acid, or acetic acid. The acidic catalysts may be used in concentrations of 0.01 to 1.0 weight percent, based on the starting materials. The catalyst acid may then be advantageously neutralized with a base, for example, with sodium hydroxide, sodium methylate or tertiary amines.

As discussed above, the wax component of the bio-based wax compositions may include insect waxes. In one embodiment, the insect wax includes beeswax.

In one embodiment, the bio-based wax compositions of the present invention contain from 50 to 99 weight percent of the wax component, based on weight of the wax composition.

In further embodiments, the bio-based wax compositions of the present invention contain from 1 to 50 weight percent of the non-hydrogenated epoxy product, based on weight of the wax composition. Preferred are wax compositions containing from 1 to 30 weight percent of the non-hydrogenated epoxy product, based on weight of the wax composition. Most preferred are wax compositions containing from 10 to 30 weight percent of the non-hydrogenated epoxy product, based on weight of the wax composition

In one embodiment, bio-based wax composition is a solid at 25° C.

As discussed above, the non-hydrogenated epoxy product of the present invention may include epoxides of non-hydrogenated vegetable oils. In this embodiment, suitable epoxides of vegetable oils include epoxides of soybean oil, palm oil, peanut oil, olive oil, cotton seed oil, linseed oil, sesame oil, sunflower oil, canola oil, rapeseed oil, jatropha oil, algae oil, tall oil, tung oil, and the like. Epoxides of soybean oil are preferred.

Exemplary non-hydrogenated epoxy products include epoxidized soybean oil (ESBO), which is commercially available as Drapex® 6.8 from Galata Chemicals, LLC (Hahnville, La., USA), and epoxidized linseed oil, which is commercially available as Drapex® 10.4 from Galata Chemicals, LLC.

As discussed above, the non-hydrogenated epoxy product may be epoxides of fatty acid esters. Preferred are epoxides of C₆-C₄₀ fatty acid esters. Most preferred are epoxides of C₈-C₂₂ fatty acid esters. Suitable epoxides of fatty acid esters include epoxidized methyl soyate and epoxidized 2-ethylhexy tallate.

An exemplary non-hydrogenated epoxy product is commercially available as Drapex® 4.4 (epoxide of 2-ethylhexyl tallate) from Galata Chemicals, LLC.

In one embodiment, the bio-based wax composition may further comprise one or more wax products selected from the group consisting of paraffin waxes, waxes of fully hydrogenated vegetable oils and partially hydrogenated vegetable oil, fatty acids, polyol fatty acid partial esters, products of transesterification of fully and partially hydrogenated vegetable oils, products of transesterification of polyol fatty acid partial esters, and mixtures thereof. Suitable fully and partially hydrogenated vegetable oils include fully and partially hydrogenated soybean oil, palm oil, peanut oil, olive oil, cotton seed oil, linseed oil, sesame oil, sunflower oil, canola oil, oil, jatropha oil, algae oil, etc. Exemplary fatty acids include palmitic acid, stearic acid, and the like. Suitable polyol fatty acid partial esters include glycerol monostearate, glycerol distearate, glycerol monopalmitate, glycerol dipalmitate, glycerol mono-oleate, glycerol di-oleate, sorbitan monolaurate, and the like.

In one embodiment, the bio-based wax compositions are prepared via melt blending. Melt blending may be conducted at a temperature of from 30° C. to 500° C. for a duration of from 0.1 to 10 hours.

According to other embodiments, the embodiments of the present invention may be used in candle compositions. The candle compositions may optionally contain colorants, fragrances, insect repellants, antioxidants, UV-stabilizers and mixtures thereof. The candle composition may also include a wick. Suitable additives for candle compositions are described in U.S. Pat. Nos. 6,063,144 and 6,503,285, the entire contents and disclosure of which are hereby incorporated by reference. When present, the amount of total additives in the composition is generally in the range from 0.01 to 20 weight percent, e.g., from 0.5 to 10 weight percent or from 1 to 5 weight percent, based on total weight of the candle.

The colorant is an optional ingredient and is commonly made up of one or more pigments and dyes. Particularly suitable colorants include titanium dioxide, zinc oxide white, copper, bronze, aluminum metal powders and flakes, phthalocyanine blue, phthalocyanine green, yellow and red pigments of the benzimide azolone group, etc.

The fragrance may be a synthetically formed material or a naturally derived oil, such as oil of basil, bergamot, bitter orange, citrus, lemon, mandarin, caraway, cedar leaf, clove leaf, cedar wood, geranium, jasmine, lavender, orange, origanum, rosemary, petitgrain, white cedar, patchouli, lavandin, neroli, vanilla, rose, etc.

Other applications may include composite materials, e.g. artificial firelogs, containing various fillers, such as carbon black, wood, talc, clay, calcium carbonate, titanium dioxide, glass, fiber glass, cellulosic and other synthetic and natural fibers, and mixtures thereof. When present, the proportion of fillers in the composition is generally in the range from 0.01 to 50 weight percent, based on the total weight of the composite materials.

### EXAMPLES

### Materials

Refined White Beeswax NF (marketed by Frank B. Ross, Inc.)

Epoxidized soybean oil (ESBO—marketed by Galata Chemicals, LLC)

Wick: CD-8 (manufactured by Heinz Verhaegh Corporation and marketed by Wicks Unlimited, Inc.)

Burn rate was measured as weight loss over total burn time.

### Comparative Example 1

Beeswax (67.0 g) was melted and poured at 165° F. into a standard glass container with the inserted wick, cooled down to ambient temperature of 68° F. and lit. The results are in Table 1.

### Comparative Example 2

Beeswax (60.3 g) and liquid castor oil (6.7 g) were melt-blended and poured at 165° F. into a standard glass container with the inserted wick, cooled down to ambient temperature of 68° F. and lit. The results are in Table 1.

### Example 1

Beeswax (60.3 g) and liquid non-hydrogenated epoxidized soybean oil (6.7 g) were melt-blended and poured at 165° F. into a standard glass container with the inserted wick, cooled down to ambient temperature of 68° F. and lit. The results are in Table 1.

### Example 2

Beeswax (46.9 g) and liquid non-hydrogenated epoxidized soybean oil (20.1 g) were melt-blended and poured at 165° F. into a standard glass container with the inserted wick, cooled down to ambient temperature of 68° F. and lit. The results are in Table 1.

TABLE 1
Burning characteristics of candle wax containing
beeswax and epoxidized soybean oil

| | | | | | | Time to |
|---|---|---|---|---|---|---|
| | | | | | | reach |
| | Total | | Total burn | Average | | widest |
| | amount | Total burn | time | burn rate, | Burn rate | diameter, |
| Examples | burnt, g | time, hrs. | increase, % | g/hr. | decrease, % | min. |
| Comparative | 60.01 | 19 | — | 3.16 | — | 90 |
| Example 1 | | | | | | |
| Comparative | 52.98 | 19 | 0 | 2.79 | 12 | 600 |
| Example 2 | | | | | | |
| Example 1 | 52.29 | 23 | 21 | 2.27 | 28 | 90 |
| Example 2 | 49.98 | 23 | 21 | 2.17 | 31 | 90 |

As can be seen from Table 1, the addition of liquid non-hydrogenated epoxidized soybean oil to beeswax in Examples 1 and 2 surprisingly resulted in an increase of burn time by over 20%, a decrease in burn rate by about 30% and unchanged time required for reaching the widest burn diameter. These results are surprising when compared to Comparative Example 2 where the addition of liquid castor oil had no effect on the total burn time while decreasing the burn rate by only 12% and tremendous (more than six times) increase in time needed to reach the widest diameter.

What is claimed is:

1. A wax composition comprising:
at least one non-hydrogenated epoxy product selected from the group consisting of epoxides of vegetable oils, epoxides of fatty acid esters, chemically modified derivatives of non-hydrogenated epoxy products, and mixtures thereof; and
at least one wax component comprising insect wax.

2. The wax composition of claim 1, wherein the at least one non-hydrogenated epoxy product comprises epoxidized soybean oil.

3. The wax composition of claim 1, wherein the at least one non-hydrogenated epoxy product comprises epoxidized linseed oil.

4. The wax composition of claim 1, wherein the at least one non-hydrogenated epoxy product comprises epoxidized 2-ethylhexyl tallate.

5. The wax composition of claim 1, wherein the at least one non-hydrogenated epoxy product comprises epoxidized methyl soyate.

6. The wax composition of claim 1, wherein the chemically modified derivatives of non-hydrogenated epoxy products comprise the products obtained by transesterification of non-hydrogenated epoxy products with C₁-C₂₀ alcohols.

7. The wax composition of claim 1, wherein the chemically modified derivatives of non-hydrogenated epoxy products comprise the products obtained by acid-catalyzed ring-opening reactions of non-hydrogenated epoxy products with C₁-C₂₀ alcohols, fatty acids, or C₁-C₂₀ organic acids.

8. The wax composition of claim 1 being a solid at 25° C.

9. The wax composition of claim 1, wherein the insect wax comprises beeswax.

10. The wax composition of claim 1 further comprising a wax product selected from the group consisting of paraffin wax, fully hydrogenated vegetable oils, partially hydrogenated vegetable oil, fatty acids, polyol fatty acid partial esters, products of trans-esterification of fully and partially hydrogenated vegetable oils, products of trans-esterification of polyol fatty acid partial esters, and mixtures thereof.

11. The wax composition of claim 10, wherein the partially hydrogenated vegetable oil is derived from soybean oil, palm oil, olive oil, cotton seed oil, linseed oil, sunflower oil, canola oil, castor oil, rapeseed oil, jatropha oil, and algae oil.

12. The wax composition of claim 10, wherein the fully hydrogenated vegetable oil is derived from soybean oil, palm oil, olive oil, cotton seed oil, linseed oil, sunflower oil, canola oil, oil, jatropha oil, and algae oil.

13. The wax composition of claim 10, wherein the fatty acids comprise palmitic acid or stearic acid.

14. The wax composition of claim 10, wherein the polyol fatty acid partial esters are selected from the group consisting of glycerol monostearate, glycerol distearate, glycerol monopalmitate, glycerol dipalmitate, glycerol mono-oleate, glycerol di-oleate, or sorbitan monolaurate.

15. The wax composition of claim 1 comprising from 1 wt. percent to 50 wt. percent, based on the total weight of the wax composition, of the at least one non-hydrogenated epoxy product and wherein the at least one wax component comprises insect wax.

16. The wax composition of claim 15 further comprising a wax product selected from the group consisting of paraffin wax, fully hydrogenated vegetable oils, partially hydrogenated vegetable oil, fatty acids, polyol fatty acid partial esters, products of trans-esterification of fully and partially hydrogenated vegetable oils, products of trans-esterification of polyol fatty acid partial esters, and mixtures thereof.

17. The wax composition of claim 15, wherein the at least one non-hydrogenated epoxy product comprises epoxides of vegetable oils and the at least one wax component comprises beeswax.

18. The wax composition of claim 17, wherein the epoxides of vegetable oils comprise epoxidized soybean oil.

19. The wax composition of claim 1 comprising from 1 wt. percent to 50 wt. percent, based on the total weight of the wax composition, of the at least one non-hydrogenated epoxy product, and wherein the at least one non-hydrogenated epoxy product comprises epoxidized soybean oil and the at least one wax component comprises beeswax.

20. The wax composition of claim 1, wherein the at least one non-hydrogenated epoxy product is from 10 wt. percent to 30 wt. percent of the total weight of the wax composition.

21. The wax composition of claim 1, wherein the at least one non-hydrogenated epoxy product is selected from the group consisting of epoxides of vegetable oils, epoxides of fatty acid esters, and mixtures thereof, and the at least one wax component comprises beeswax.

22. The wax composition of claim 21 further comprising a wax product selected from the group consisting of paraffin wax, fully hydrogenated vegetable oils, partially hydrogenated vegetable oil, fatty acids, polyol fatty acid partial esters, products of trans-esterification of fully and partially hydrogenated vegetable oils, products of trans-esterification of polyol fatty acid partial esters, and mixtures thereof.

23. The wax composition of claim 21, wherein the epoxides of vegetable oils comprise epoxidized soybean oil or epoxidized linseed oil.

24. The composition of claim 21, wherein the epoxides of fatty acid esters comprise methyl soyate or 2-ethylhexyl tallate.

25. A candle composition comprising the wax composition of claim 1.

26. The candle composition of claim 25 further comprising one or more additives selected from the group consisting of colorants, fragrances, insect repellants, antioxidants, UV-stabilizers, and mixtures thereof.

27. A candle composition comprising the wax composition of claim 21.

28. The candle composition of claim 27 further comprising one or more additives selected from the group consisting of colorants, fragrances, insect repellants, antioxidants, UV-stabilizers, and mixtures thereof.

29. A method for making a wax composition comprising blending
at least one non-hydrogenated epoxy product selected from the group consisting of epoxides of vegetable oils, epoxides of fatty acid esters, chemically modified derivatives of non-hydrogenated epoxy products, and mixtures thereof; and
at least one wax component comprising insect wax.

30. The method of claim 29, wherein the blending is melt-blending.

31. The method of claim 30, wherein the melt-blending is conducted at a temperature of from 30° C. to 500° C.

32. The method of claim 30, wherein the melt-blending is conducted for from 0.1 to 10 hours.

33. A composite material comprising the wax composition of claim 1.

34. The composite material of claim 33 further comprising a filler.

35. The composite material of claim 33 comprising from 0.01 wt. percent to 50 wt. percent of the filler, based on total weight of the composite material.
